(19) United States
(12) Patent Application Publication
(10) Pub. No.: US 2007/0081269 A1
(43) Pub. Date: Apr. 12, 2007

(54) Hard disk drive having improved shock resistance

(75) Inventors: Cheol-soon Kim, Anyang-si (KR); Sung-kwon Choi, Seoul (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/516,578

(22) Filed: Sep. 7, 2006

(30) Foreign Application Priority Data
Oct. 12, 2005 (KR) 10-2005-0096170

(51) Int. Cl. G11B 33/14

(52) U.S. Cl. 360/97.02

(57) ABSTRACT

A hard disk drive having an improved shock resistance includes a spindle motor mounted on a frame member, at least one data storage disk positioned on and rotatable with the spindle motor, an actuator pivotally installed on the frame member and including a slider mounted on a side thereof to move the slider to a predetermined position on the disk while the actuator swings on the frame, a ramp provided outside of the disk to support a leading end of the actuator when the slider is rested thereon, and a cover member facing the frame member from a top of the ramp, the cover member including a protrusion protruding toward at least one portion of the ramp.

### CROSS-REFERENCE TO RELATED APPLICATIONS

This application claims priority under 35 U.S.C. §119(a) from Korean Patent Application No.10-2005-0096170, filed on Oct. 12, 2005, in the Korean Intellectual Property Office, the disclosure of which is incorporated herein in its entirety by reference.

### BACKGROUND OF THE INVENTION

1. Field of the Invention

The present general inventive concept relates to a hard disk drive, and more particularly, to a hard disk drive having an improved shock resistance.

2. Description of the Related Art

A hard disk drive includes an actuator to move a read/write head to a predetermined position above a data storage disk for recording and reading data, and a spindle motor rotating the disk at a high speed. The hard disk drive records data in the disk or reads data from the disk. When the hard disk drive is powered-on and the disk starts rotating, the actuator moves the head above a recording surface of the disk and the head is lifted above the recoding surface of the disk to a predetermined height by a lift force generated by the disk rotating at a high speed. The lifted-up head tracks a specific track of the disk to execute the read/write functions. When the hard disk drive is powered-off, the actuator moves the head from the recording surface to a ramp located apart from the disk for parking the head when the head is not in use.

FIG. 1 is a view illustrating main portions of a conventional hard disk drive. Referring to FIG. 1, an actuator 30 is provided between a cover member 11 and a base member 12 that face each other. Suspensions 35 are mounted on a leading end of the actuator 30, and sliders 36 with read/write heads (not illustrated) are attached to the suspensions 35. If data are recorded on both sides of a disk, a pair of suspensions 35 is provided for both sides of the disk. The suspensions 35 elastically bias the sliders 36 toward recording surfaces of the disk, and the sliders 36 biased by the suspensions 35 are lifted up from the recording surfaces of the disk to a predetermined height where an elastic force of the suspensions 35 and a lift force caused by a rotation of the disk balance each other. In detail, each of the suspensions 35 includes a rod beam 33 and a flexure 34. The rod beam 33 and the flexure 34 are in contact with each other through a dimple 39 formed on the rod beam 33. The dimple 39 keeps the rod beam 33 and the flexure 34 at a predetermined distance from each other. Therefore, the flexure 34, on which the slider 36 is installed, can be placed in a position to be lifted above the disk while the flexure 34 vibrates with respect to the rod beam 33, thereby stabilizing the lifting of the slider 36.

When the hard disk drive is not rotating, the sliders 36 rest on a ramp 60 spaced apart from the disk. In this state, if the disk receives an impact force, for example, a vertical force from above the disk, the suspensions 35 having relatively low rigidity are bent downward and then bent upward by their elasticity in gap (g′). At this time, an end tap 38 of the rod beam 33 collides with the cover member 11 and bends downward due to a reaction force generated by the collision with the cover member 11. Therefore, while the confronting sliders 36 vertically vibrate with the suspensions 35, the sliders 36 can collide with each other, increasing a possibility of damage to the sliders 36.

Further, if the suspensions 35 are permanently deformed due to a vibration exceeding their elastic limits, and especially if the flexures 34 on which the sliders 36 are installed are permanently deformed, the sliders 36 cannot be stably lifted above the disk, thereby causing reliability problems of the hard disk drive, such as a non-uniform gap between recording surfaces of the disk and the sliders 36 due to the unstable lifting of the sliders 36.

### SUMMARY OF THE INVENTION

The present general inventive concept provides a hard disk drive that restricts an elastic vibration of a suspension caused by an impact within a predetermined range to lower a damage to a read/write head attached to the suspension and to prevent deformation of the suspension, thereby ensuring lifting stability of the read/write head during data recording/reading.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a hard disk drive, including a spindle motor mounted on a frame member, at least one data storage disk positioned on and rotatable with the spindle motor, an actuator pivotally installed on the frame member and including a slider mounted on a side of the actuator to move the slider to a predetermined position on the disk while the actuator swings on the frame, a ramp spaced apart from the disk to support a leading end of the actuator when the slider is parked on the ramp, and a cover member facing the frame member from a top of the ramp and including a protrusion protruding toward at least one portion of the ramp.

The ramp may include a first inclined surface to guide the leading end of the actuator away from a surface of the disk when the actuator reaches the ramp, an end tap moving surface to horizontally guide the leading end spaced apart from the surface of the disk, a second inclined surface sloped in an opposite direction to the first inclined surface, and an end tap stopping surface to support the leading end when the leading end stops.

The protrusion may protrude toward the end tap stopping surface and may have a bottom parallel with the end tap stopping surface so that a uniform clearance gap is formed between the bottom of the protrusion and the end tap stopping surface. The protrusion may protrude toward the end tap stopping surface and have a bottom having a predetermined curvature.

The protrusion may be formed integrally with the cover member by pressing-in a portion of the cover member toward the ramp.

The hard disk drive may further include a buffer attached to a bottom of the protrusion facing the ramp to absorb a vibration of the actuator.

The foregoing and/or other aspects and utilities of the present general inventive concept may be achieved by providing a hard disk drive, including a spindle motor mounted on a frame member, at least one data storage disk positioned on and rotatable with the spindle motor, an actuator pivotally installed on the frame member and including a slider mounted on a side of the actuator to move the slider to a predetermined position on the disk while the actuator swings on the frame, a ramp spaced apart from the disk, the ramp including a first inclined surface to guide a leading end of the actuator away from a surface of the disk when the actuator is parked on the ramp and an end tap stopping surface to support the leading end when the leading end stops, and a cover member facing the frame member from a top of the ramp and including a protrusion protruded toward the ramp across the first inclined surface and the end tap stopping surface.

The ramp may further include an end tap moving surface between the first inclined surface and the end tap stopping surface to horizontally guide the leading end spaced apart from the surface of the disk, and a second inclined surface between the first inclined surface and the end tap stopping surface, the second surface being sloped in an opposite direction to the first inclined surface.

The protrusion may include a first inclined protrusion surface, a first horizontal protrusion surface, a second inclined protrusion surface, and a second horizontal protrusion surface that are parallel with the first inclined surface, the end tap moving surface, the second inclined surface, and the end tap stopping surface of the ramp, respectively to maintain a uniform clearance gap between the protrusion and the ramp.

The protrusion may be formed integrally with the cover member by pressing a portion of the cover member toward the ramp.

The hard disk drive may further include a buffer attached to a bottom of the protrusion facing the ramp to absorb a vibration of the actuator.

The foregoing and/or other aspects and utilities of the present general inventive concept may be achieved by providing a hard disk drive, including a rotatable disk having a surface to contain information, an actuator having an end to read the information from or to record the information to the rotatable disk, a parking unit spaced apart from the surface of the rotatable disk by a predetermined distance to receive the end of the actuator when the actuator does not read the information from or record the information to the rotatable disk, a cover member to cover at least the parking unit and having a major surface to maintain a distance with a portion of the parking unit, and a spacing unit located on the major surface of the cover member at a position corresponding to a position of the parking unit to maintain a second distance with the portion of the parking unit.

The second distance between the spacing unit and the parking unit may be smaller than the distance between the major surface of the cover member and the portion of the parking unit. The spacing unit may restrict a movement of the end of the actuator in a substantially vertical direction to be within the second distance when the end of the actuator is stored on the parking unit. The spacing unit may protrude from the major surface of the cover member toward the portion of the parking unit. The spacing unit and the cover member may be formed in a single monolithic body.

The spacing unit may include a material to absorb a force generated by a contact between the actuator and the spacing unit. The material may include at least one of a sponge material and a rubber material. The spacing unit may have an angular cross-section or a curved cross-section to correspond to the portion of the parking unit. The spacing unit may have a shape to substantially correspond to a shape of the parking unit to maintain the second distance between the spacing unit and the parking unit along an entire length of the parking unit. The parking unit may include a plurality of surfaces to guide the actuator to a resting position thereon, and the second distance is a distance between the spacing unit and the resting position.

The foregoing and/or other aspects and utilities of the present general inventive concept may be achieved by providing a hard disk drive, including a frame member and a cover member to provide a space, a disk disposed in the space, an actuator having a main portion spaced apart from the cover member by a first distance to move with respect to the disk and to move between a parking area and an information reading and/or recording area, a ramp having at least one surface to receive a distal end of the actuator when the actuator moves to the parking area, and a spacing unit formed on the cover member to correspond to the at least one surface of the ramp to have a second distance with the distal end of the actuator.

The second distance may be shorter than the first distance so that a movement of the actuator in a direction having an angle with the information reading and/or recording area of the disk is restricted within the second distance. The ramp may include a vibration restricting wall formed to face a surface opposite to the at least one surface to have a third distance with the at least one surface. The spacing unit may restrict the distal end of the actuator within the second distance and a second distal end of the actuator within the third distance.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating main portions of a conventional hard disk drive;

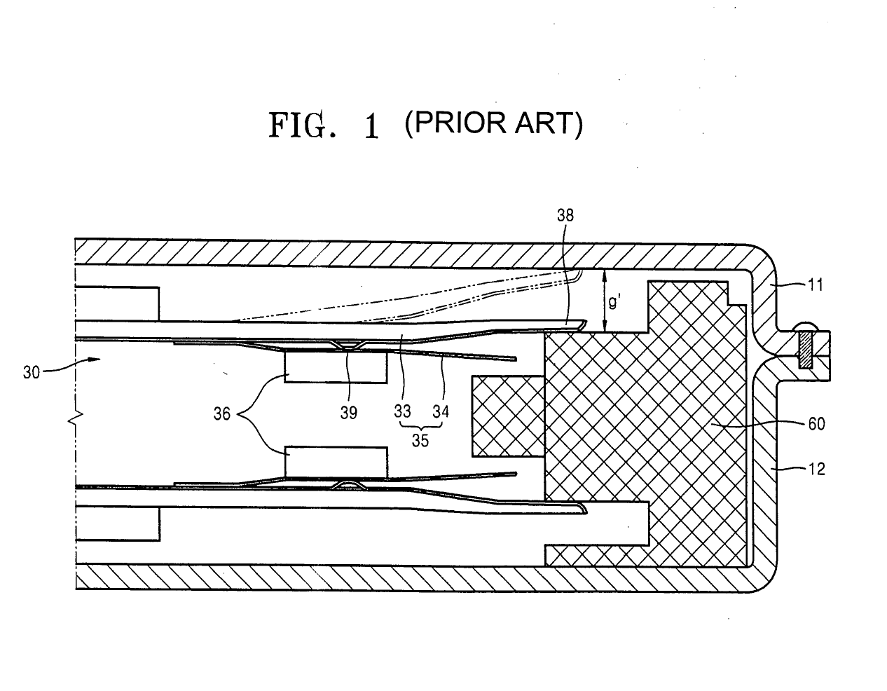

FIG. 2 is a perspective view illustrating a structure of a hard disk drive according to an embodiment of the present general inventive concept;

FIG. 3 is a perspective view illustrating main portions of the hard disk drive of FIG. 2;

FIG. 4 is a cross-sectional view taken along line IV-IV of FIG. 3;

FIG. 5 is a perspective view illustrating main portions of a hard disk drive according to another embodiment of the present general inventive concept; and

FIG. 6 is a cross-sectional view taken along line VI-VI of FIG. 5.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

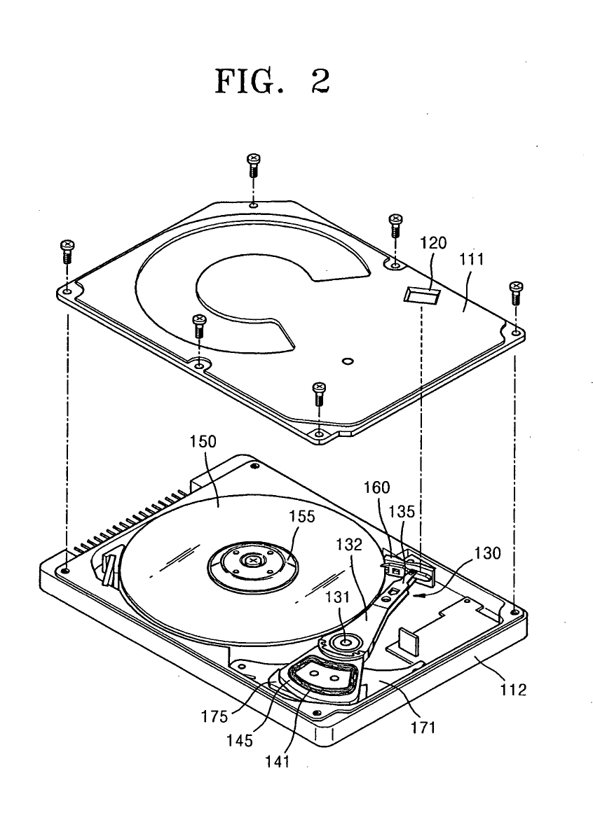

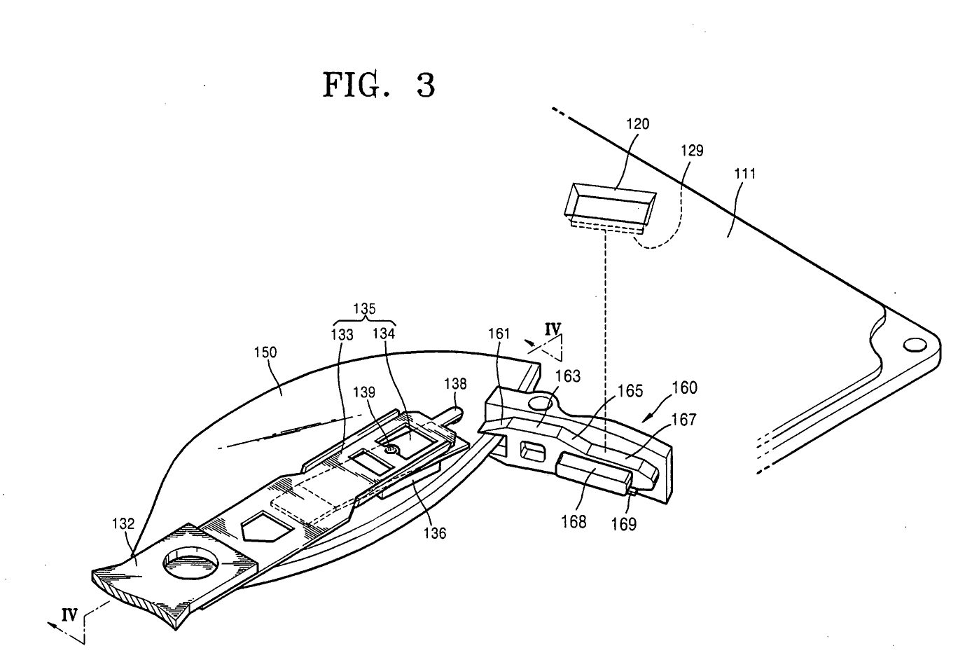

FIG. 2 is an exploded perspective view schematically illustrating a structure of a hard disk drive according to an embodiment of the present general inventive concept, and FIG. 3 is a perspective view illustrating the hard disk drive of FIG. 2.

Referring to FIGS. 2 and 3, the hard disk drive includes a spindle motor 155 to rotate a data storage disk 150, an actuator 130 pivotally installed apart from the disk 150 and having a read/write head (not illustrated) on a leading end to move the read/write head to a desired position above the disk 150, and a voice coil motor to drive the actuator 130.

The spindle motor 155 is installed on a frame member 112 of the hard disk drive. One or more of the data storage disks 150 are mounted on the spindle motor 155 and are rotatable at a predetermined angular speed by the spindle motor 155. The disk 150 is coupled with a rotor of the spindle motor 155 and rotates together with the rotor. The disk 150 includes a recording surface to record data and a non-recording surface for other purposes.

The actuator 130 includes an actuator pivot 131, a swing arm 132, a suspension 135, and a coil support 145 that are installed on the frame member 112. The swing arm 132 is rotatably coupled to the actuator pivot 131. The suspension 135 is coupled to a leading end of the swing arm 132 to elastically bias a read/write head (not illustrated) toward the surface of the disk 150. Referring to FIG. 3, the suspension 135 includes a rod beam 133 coupled to the leading end of the swing arm 132 and a flexure 134 to which a slider 136 is supportably attached. The rod beam 133 and the flexure 134 are in contact with each other through a dimple 139 recessed downward from the rod beam 133. Therefore, the rod beam 133 and the flexure 134 can be spaced a predetermined distance apart from each other by the dimple 139 to allow the slider 136 attached to the flexure to vibrate with respect to the rod beam 133. The rod beam 133 includes an end tap 138 on a leading end thereof. By resting the end tap 138 on a ramp 160, the slider 136 can be safely parked when the slider 136 departs from the disk 150.

The voice coil motor (VCM) provides a driving force to the swing arm 132. The interaction between a current applied to a VCM coil 141 and a magnetic field formed by a magnet 175 causes the swing arm 132 to rotate according to Fleming's left-hand rule. The VCM coil 141 is assembled to the coil support 145 coupled to a rear end of the swing arm 132. The magnet 175 is supportably attached to a yoke 171 and faces the VCM coil 141.

Though not illustrated, a flexible printed circuit can be connected to the actuator 130 to transmit an operation or stop signal. According to the signal, the slider 136 is loaded onto the disk or unloaded off of the disk and spaced apart from the disk.

The spindle motor 155 and the actuator 130 are accommodated in a space defined by the frame member 112 and a cover member 111 that face each other in a vertical direction. The frame member 112 and the cover member 111 prevent permeation of foreign substances, protect inner components, and prevent an operation noise from being transmitted to outside of the hard disk drive. The cover member 111 has a protrusion (or a spacing unit) 120 at a predetermined position to restrict a movement of the suspension 135 within a predetermined range (described later in detail). The frame member 112 and the cover member 111 may be formed using a sheet material, such as an aluminum sheet or a steel sheet, through a press working process.

When the hard disk drive is powered on and the disk 150 is rotating, the voice coil motor rotates the swing arm 132 in a predetermined direction (e.g., counterclockwise) to load the slider 136 onto a recording surface of the disk 150. The slider 136 is lifted up to a predetermined height from the surface of the disk 150 by a lift force generated by the rotation of the disk 150. In this state, the slider 136 tracks a specific track of the disk 150, and a magnetic head (not illustrated) mounted on the slider 136 records data on the recording surface of the disk 150 or reads data from the recording surface of the disk 150.

Meanwhile, when the hard disk drive is powered off and the disk 150 is not rotating, the voice coil motor rotates the swing arm 132 in an opposite direction (e.g., clockwise) to move the slider 136 off of the recording surface of the disk 150. The slider 136 moved from the recording surface of the disk 150 is rested on the ramp 160 located apart from the disk 150.

The ramp 160 has a first inclined surface 161, an end tap moving surface 163, a second inclined surface 165, and an end tap stopping surface 167. The first inclined surface 161 lifts up the end tap 138 from the surface of the disk 150 when the end tap 138 is moved from a rotating center of the disk 150 toward an outside of the disk 150 or away from the disk 150. The end tap moving surface 163 extends in a horizontal direction such that the end tap 138 maintains a sufficient distance from the surface of the disk 150 and can move horizontally. The second inclined surface 165 is sloped in an opposite direction to the first inclined surface 161. The end tap 138 stops on the end tap stopping surface 167. The ramp 160 further includes a slider supporting surface 168 to support the slider 136 when the end tap 138 rests on the end tap stopping surface 167. The ramp 160 further includes a vibration restricting wall 169 (described later) on a lower portion thereof.

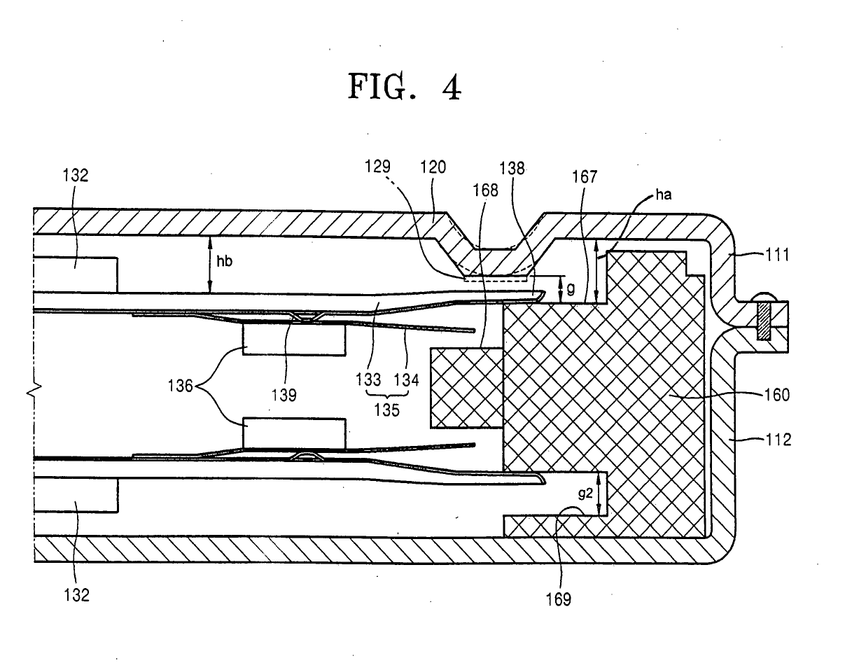

Meanwhile, the protrusion 120 of the cover member 111 protrudes toward the end tap stopping surface 167 and has a predetermined height. That is, the protrusion 120 is formed on a portion of the cover member 111 facing the ramp 160, i.e., the end tap stopping surface 167. FIG. 4 is a cross-sectional view illustrating the hard disk drive of FIG. 3 taken along line IV-IV of FIG. 3, when the slider 136 is rested on the ramp 160. As illustrated in FIG. 4, a clearance gap (g) is located between the protrusion 120 and the end tap stopping surface 167 such that an interference between the end tap 138 and the cover member 111 can be prevented when the end tap 138 moves onto the end tap stopping surface 167 or departs from the end tap stopping surface 167. The clearance gap (g) should be as small as possible in size, as long as a movement of the end tap 138 is not hindered, to increase a shock resistance of the hard disk drive. This will now be described.

If the hard disk drive receives an impact in an approximately vertical direction when the end tap 138 rests on the end tap stopping surface 167, for example, when the impact is in an impact in an upward direction, the suspension 135 that is formed on the leading end of the actuator 130 and has a relatively low rigidity is bent downward and springs back upward due to an elasticity thereof. In this case, the end tap 138 moves up rapidly with the suspension 135 to collide with the cover member 111, and thus the suspension 135 is moved downward again by a reaction force generated by the collision with the cover member 111. While the suspension 135 is repeatedly oscillated in this way, a vertical displacement of the end tap 138 is determined by the clearance gap (g). If the vertical movement of the end tap 138 is restricted within a predetermined range, the oscillation of the suspension 135 can be decreased to reduce a force acting on the slider 136 attached to the suspension 135. In the present embodiment, the protrusion 120 protrudes from the cover member 111 toward the end tap stopping surface 167 to uniformly restrict a size of the clearance gap (g)to prevent an acceleration of the collision of the suspension 135 with the cover member 111.

A cross-section of the protrusion 120 can have any shape, as long as the protrusion 120 protrudes toward the ramp 160 to restrict the size of the clearance gap (g). For example, as illustrated in FIG. 4, the protrusion 120 can have an angled cross-sectional shape (indicated by solid lines in FIG. 4) or a curved cross-sectional shape (indicated by dashed lines in FIG. 4). The angled or curved shape of the protrusion 120 may be formed in a rotation direction of the swing arm 132 with respect to the actuator pivot 131 and/or in a circumferential direction of the swing arm 132 with respect to the actuator 131.

Meanwhile, the suspension 135 and the slider 136 attached thereto are provided as a pair of suspensions 135 and a pair of sliders 136 in FIG. 4. The pair of suspensions 135 with the sliders 136 face each other from above (i.e., an upper suspension 135) and below (i.e., a lower suspension 135) the disk 150 in a vertical direction. If an impact force is applied to the hard disk drive, the end tap 138 of the upper suspension 135 vertically vibrates between the end tap stopping surface 167 and the protrusion 120. In particular, a vibrating amplitude of the end tap 138 of the upper suspension 135 is restricted by the protrusion 120. Similarly, the end tap 138 of the lower suspension 135 vertically vibrates between the end tap stopping surface 167 and the vibration restricting wall 169 of the ramp 160, and a vertical displacement of the end tap 138 of the lower suspension 135 is restricted by the vibration restricting wall 169 to be within a gap (g2) when an impact force is applied to the hard disk drive, so that damage to the lower suspension 135 and the lower slider 136 attached thereto can be prevented.

The protrusion 120 may be formed integrally with the cover member 111, such as by press deforming the cover member 111 at a portion facing the ramp 160. The cover member 111 may be press deformed to form a joint portion to be coupled with the frame member 112. Therefore, the protrusion 120 of the present embodiment can be formed by altering a shape of a press die according to a shape of the protrusion 120 without using an additional process to form the protrusion 120.

Meanwhile, a buffer 129 may be attached to the protrusion 120 at a bottom of the protrusion 120 facing the ramp 160 to restrain the vibration of the suspension 135 by absorbing a striking energy of the end tap 138 and reducing a reaction force of the protrusion 120 acting on the end tap 138 when the end tap 138 collides with the protrusion 120. The buffer 129 may be formed of any material having a damping characteristic for to absorb a shock. For example, a pad formed of a sponge or a rubber (such as silicon rubber) can be used as the butter 129. When the buffer 129 is attached to the bottom of the protrusion 120, a vibration energy of the end tap 138 moving up and down between the end tap stopping surface 167 and the protrusion 120 can be absorbed, thereby rapidly dampening the vibration and efficiently protecting the suspension 135.

As illustrated in FIG. 4, a major surface of the cover member 111 is spaced apart from the end tap stopping surface 167 of the ramp 160 by a distance ha, which is longer than the clearance gap (g), and is also spaced apart from the rod beam 133 of the suspension 135 by a distance hb, which is longer than the clearance gap (g). Since the protrusion 120 protrudes from the major surface of the cover member 111 by a predetermined height to have the clearance gap (g) with the ramp 160, i.e., the end tap stopping surface 167, the end tap 138 is restricted to move within the clearance gap (g) instead of within the distance ha. The protrusion 120 can be formed on portions of the cover member 111 facing the slider supporting surface 168 and the end tap stopping surface 167. That is, a middle portion of the protrusion 120 may be disposed between the slider supporting surface 168 and the end tap stopping surface 167. It is possible that a distal end of the end tap 138 may be disposed to contact the protrusion 120 during a vibration.

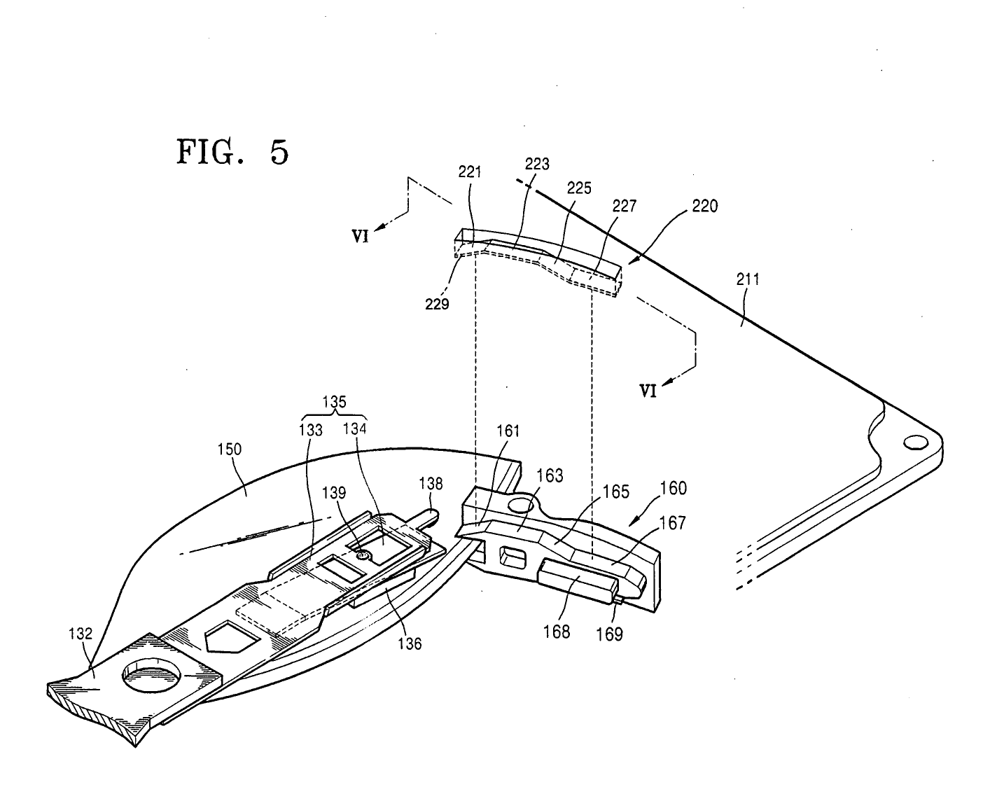

FIG. 5 is a perspective view illustrating main portions of a hard disk drive according to another embodiment of the present general inventive concept. Referring to FIG. 5, the hard disk drive includes a ramp 160 spaced apart from a disk 150 to receive a slider 136 when the slider 136 departs from the disk 150. The ramp 160 includes a plurality of supporting surfaces 161, 163, 165, and 167 to guide an end tap 138 to rest the end tap 138 without colliding with the disk 150. In detail, the ramp 160 includes a first inclined surface 161, an end tap moving surface 163, a second inclined surface 165, and an end tap stopping surface 167. The first inclined surface 161 distances the end tap 138 from a surface of the disk 150. The end tap moving surface 163 extends in a horizontal direction to maintain a sufficient distance from the surface of the disk 150 and can move horizontally. The second inclined surface 165 is sloped in an opposite direction to the first inclined surface 161. The end tap 138 stops on the end tap stopping surface 167.

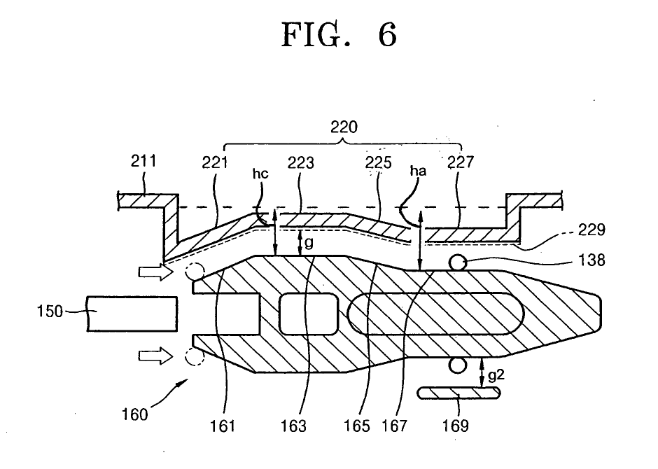

FIG. 6 is a cross-sectional view illustrating the hard disk drive of FIG. 5 taken along line VI-VI of FIG. 5. Referring to FIGS. 5 and 6, a cover member 211 includes a protrusion 220 protruding toward the ramp 160. The protrusion 220 has a shape corresponding to a shape of the ramp 160, such that a clearance gap (g) between the protrusion 220 and the supporting surfaces 161, 163, 165, and 167 can be uniformly maintained. In detail, the protrusion 220 includes a first inclined surface 221, a first horizontal surface 223, a second inclined surface 225, and a second horizontal surface 227. The first inclined surface 221 is upwardly sloped along the first inclined surface of the ramp 160. The first horizontal surface 223 extends in a horizontal direction in correspondence with the end tap moving surface 163 of the ramp 160. The second inclined surface 225 is downwardly sloped in correspondence with the second inclined surface 165 of the ramp 160. The second horizontal surface 227 extends in a horizontal direction in correspondence with the end tap stopping surface 167 of the ramp 160. However, the shape of the protrusion 220 can be changed according to the shape of the corresponding ramp 160. That is, the present general inventive concept is not limited to the shape of the protrusion 220 illustrated in FIGS. 5 and 6.

The protrusion 220 improves a shock resistance of the hard disk drive in a substantially similar way as described with reference to FIG. 3. In the embodiment illustrated in FIG. 3, the protrusion 120 corresponds to the end tap stopping surface 167 of the ramp 160 and operates after the end tap 138 rests on the end tap stopping surface 167. However, in this embodiment illustrated in FIGS. 5 and 6, the protrusion 220 has an elongated shape corresponding to an entire length of the ramp 160, and the protrusion 220 can restrict a vertical displacement of the end tap 138 caused by an impact within the preset clearance gap (g) before the end tap 138 rests on the end tap stopping surface 167 (e.g., after the tap 138 reaches the first inclined surface 161 of the ramp 160), so that an undulating vibration of a suspension 135 can be significantly restrained.

In detail, when the end tap 138 reaches the first inclined surface 161 of the ramp 160, the end tap 138 is moved through the clearance gap (g) between the first inclined surface 161 of the ramp 160 and the first inclined surface 221 of the protrusion 220 in a direction away from the surface of the disk 150, such that a vertical displacement of the end tap 138 due to an impact during the movement of the end tap 138 can be restricted within the narrow clearance gap (g), thereby rapidly dampening an elastic vibration of the suspension 135. When the end tap 138 reaches the end tap moving surface 163 of the ramp 160, a vertical displacement of the end tap 138 is restricted within the clearance gap (g) between the first horizontal surface 223 of the protrusion 220 and the end tap moving surface 163 of the ramp 160, such that a striking energy of the end tap 138 generated by an impact can be dissipated while the end tap 138 vibrates within the clearance gap (g). If an impact force acts on the hard disk drive in an upward direction at this time, the suspension 135 is downwardly bent and rapidly springs back in the upward direction due to an elasticity thereof to collide with the protrusion 220. The suspension 135 is downwardly bent again by a reaction force generated by the collision of the suspension 135 with the protrusion 220. Because the clearance gap (g) is narrow, the vibration of the suspension 135 is not accelerated while within the clearance gap (g), thereby lowering an impact force acting on the slider 136.

The end tap 138 rests on the end tap stopping surface 167 after passing through the second inclined surface 165 of the ramp 160. That is, the end tap 138 is rested between the end tap stopping surface 167 and the second horizontal surface 227 of the protrusion 220. If an impact force acts on the hard disk drive when the hard disk drive is not operating (e.g., when the disk 150 is not rotating), the end tap 138 vertically vibrates between the end tap stopping surface 167 and the second horizontal surface 227 of the protrusion 220. However, the clearance gap (g) allowing the vibration of the end tap 138 is narrow due to the protrusion 220, so that problems including an excessive deformation of the suspension 135 and damage to the slider 136 due to a vibration acceleration can be prevented.

As illustrated in FIG. 6, a major surface of the cover member 111 has a distance ha from the end tap stopping surface 167 and a distance hc from the end tap moving surface 163. The distance hc is greater than the clearance gap (g) and smaller than the distance ha.

The protrusion 220 may be formed integrally with the cover member 211, such as by press deforming the cover member 211 at a portion facing the ramp 160. The protrusion 220 can be formed by altering a shape of a press die according to a shape of the protrusion 220 without using an additional process to form the protrusion 120.

A buffer 229 may be attached to the protrusion 220 at a bottom thereof facing the ramp 160. The buffer 229 can rapidly dampen the vibration of the suspension 135 by absorbing a striking energy of the end tap 138 when the end tap 138 collides with the protrusion 220. The buffer 229 is substantially the same as the buffer 129 described with reference to FIGS. 3 and 4. However, the buffer 229 can be attached to the protrusion 220 across an entire length of the protrusion 220 or at a portion of the protrusion 220.

Hard disk drives according to various embodiment of the present general inventive concept include a clearance gap between a cover member and a ramp thereof that can be kept narrow by a protrusion, so that an elastic vibration of a suspension can be rapidly dampened, thereby lowering an impact force acting on a read/write head attached to the suspension. Further, a permanent deformation of the suspension is prevented, such that a slider can be placed in a position to fly above a disk when the slider is lifted at a predetermined height from a recording surface of the disk to record and to read data on and from the recording surface of the disk, thereby improving a flying stability of the read/write head.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A hard disk drive, comprising:
a spindle motor mounted on a frame member;
at least one data storage disk positioned on and rotatable with the spindle motor;
an actuator pivotally installed on the frame member and including a slider mounted on a side of the actuator to move the slider to a predetermined position on the disk while the actuator swings on the frame;
a ramp spaced apart from the disk to support a leading end of the actuator when the slider is parked on the ramp; and
a cover member facing the frame member from a top of the ramp and including a protrusion protruding toward at least one portion of the ramp.

2. The hard disk drive of claim 1, wherein the ramp comprises:
a first inclined surface to guide the leading end of the actuator away from a surface of the disk when the actuator reaches the ramp;
an end tap moving surface to horizontally guide the leading end spaced apart from the surface of the disk;
a second inclined surface sloped in an opposite direction to the first inclined surface; and
an end tap stopping surface to support the leading end when the leading end stops.

3. The hard disk drive of claim 2, wherein the protrusion protrudes toward the end tap stopping surface and has a bottom parallel with the end tap stopping surface so that a uniform clearance gap is formed between the bottom of the protrusion and the end tap stopping surface.

4. The hard disk drive of claim 2, wherein the protrusion protrudes toward the end tap stopping surface and has a bottom having a predetermined curvature.

5. The hard disk drive of claim 1, wherein the protrusion is formed integrally with the cover member by pressing a portion of the cover member toward the ramp.

6. The hard disk drive of claim 1, further comprising:
a buffer attached to a bottom of the protrusion facing the ramp to absorb a vibration of the actuator.

7. A hard disk drive, comprising:
a spindle motor mounted on a frame member;
at least one data storage disk positioned on and rotatable with the spindle motor;
an actuator pivotally installed on the frame member and including a slider mounted on a side of the actuator to move the slider to a predetermined position on the disk while the actuator swings on the frame;
a ramp spaced apart from the disk, the ramp including a first inclined surface to guide a leading end of the actuator away from a surface of the disk when the actuator is parked on the ramp and an end tap stopping surface to support the leading end when the leading end stops; and
a cover member facing the frame member from a top of the ramp and including a protrusion protruding toward the ramp across the first inclined surface and the end tap stopping surface.

8. The hard disk drive of claim 7, wherein the ramp further includes:
an end tap moving surface between the first inclined surface and the end tap stopping surface to horizontally guide the leading end spaced apart from the surface of the disk; and
a second inclined surface between the first inclined surface and the end tap stopping surface, the second surface being sloped in an opposite direction to the first inclined surface.

9. The hard disk drive of claim 8, wherein the protrusion comprises a first inclined protrusion surface, a first horizontal protrusion surface, a second inclined protrusion surface, and a second horizontal protrusion surface that are parallel with the first inclined surface, the end tap moving surface, the second inclined surface, and the end tap stopping surface of the ramp, respectively, to maintain a uniform clearance gap between the protrusion and the ramp.

10. The hard disk drive of claim 7, wherein the protrusion is formed integrally with the cover member by pressing a portion of the cover member toward the ramp.

11. The hard disk drive of claim 7, further comprising:
a buffer attached to a bottom of the protrusion facing the ramp to absorb a vibration of the actuator.

12. A hard disk drive, comprising:
a rotatable disk having a surface to contain information;
an actuator having an end to read the information from or to record the information to the rotatable disk;
a parking unit spaced apart from the surface of the rotatable disk by a predetermined distance to receive the end of the actuator when the actuator does not read the information from or record the information to the rotatable disk;
a cover member to cover at least the parking unit and having a major surface to maintain a distance with a portion of the parking unit; and
a spacing unit located on the major surface of the cover member at a position corresponding to a position of the parking unit to maintain a second distance with the portion of the parking unit.

13. The hard disk drive of claim 12, wherein the second distance between the spacing unit and the portion of the parking unit is smaller than the distance between the major surface of the cover member and the parking unit.

14. The hard disk drive of claim 12, wherein the spacing unit restricts a movement of the end of the actuator in a substantially vertical direction to be within the second distance when the end of the actuator is stored on the parking unit.

15. The hard disk drive of claim 12, wherein the spacing unit protrudes from the major surface of the cover member toward the portion of the parking unit.

16. The hard disk drive of claim 12, wherein the spacing unit and the cover member are formed in a single monolithic body.

17. The hard disk drive of claim 12, wherein the spacing unit comprises a material to absorb a force generated by a contact between the actuator and the spacing unit.

18. The hard disk drive of claim 17, wherein the material comprises at least one of a sponge material and a rubber material.

19. The hard disk drive of claim 12, wherein the spacing unit has an angular cross-section or a curved cross-section to correspond to the portion of the parking unit.

20. The hard disk drive of claim 12, wherein the spacing unit has a shape to substantially correspond to a shape of the parking unit to maintain the second distance between the spacing unit and the parking unit along an entire length of the parking unit.

21. The hard disk drive of claim 20, wherein the parking unit comprises a plurality of surfaces to guide the actuator to a resting position thereon, and the second distance is a distance between the spacing unit and the resting position.

22. A hard disk drive, comprising:
a frame member and a cover member to provide a space;
a disk disposed in the space;
an actuator having a main portion spaced apart from the cover member by a first distance to move with respect to the disk and to move between a parking area and an information reading and/or recording area;
a ramp having at least one surface to receive a distal end of the actuator when the actuator moves to the parking area; and
a spacing unit formed on the cover member to correspond to the at least one surface of the ramp to have a second distance with the distal end of the actuator.

23. The hard disk drive of claim 22, wherein the second distance is shorter than the first distance so that a movement of the actuator in a direction having an angle with the information reading and/or recording area of the disk is restricted within the second distance.

24. The hard disk drive of claim 22, wherein the ramp comprises a vibration restricting wall formed to face a surface opposite to the at least one surface to have a third distance with the at least one surface.

25. The hard disk drive of claim 24, wherein the spacing unit restricts the distal end of the actuator within the second distance and a second distal end of the actuator within the third distance.
